(19) United States
(12) Patent Application Publication
(10) Pub. No.: US 2025/0359570 A1
(43) Pub. Date: Nov. 27, 2025

(54) Product and method for stabilizing lemon juice

(71) Applicants: Flor Mariela Chacon Bejarano, Bogota (CO); Kadir Alejandro Malagana Chacon, Bogota (CO); Rafael Guillermo Malagana Chacon, Bogota (CO)

(72) Inventors: Flor Mariela Chacon Bejarano, Bogota (CO); Kadir Alejandro Malagana Chacon, Bogota (CO); Rafael Guillermo Malagana Chacon, Bogota (CO)

(21) Appl. No.: 18/669,617

(22) Filed: May 21, 2024

(51) Int. Cl. A23L 2/06; A23L 3/16; A23L 3/3508; A23L 3/37; A23L 29/269; A23L 29/30

(52) U.S. Cl. CPC A23L 2/06; A23B 2/40; A23B 2/754; A23B 2/85; A23L 29/27; A23L 29/30

(57) ABSTRACT

Abstract:

The invention relates to a method for stabilizing lemon juice, by means of which the lemon, after being disinfected, is cut up in order to extract the lemon juice, but not before the natural oils contained in the lemon rind are insulated from mixing with the lemon juice via a disposable cloth, the seeds thereof are also separated, the lemon juice subsequently being subjected to a predetermined time and temperature range, then cooled to predetermined temperatures in order to generate a thermal shock, followed by the addition thereto of stabilizers and antioxidants. Finally, the lemon juice is packaged.

### CROSS-REFERENCE TO RELATED APPLICATIONS

This application is a Continuation-in-part of pending U.S. patent application Ser. No. 16/886,219 titled “Product and Method for Stabilizing lemon juice”, filed on May 28, 2020, the description of which is incorporated herein by reference in its entirety.

### FIELD OF THE INVENTION

The disclosure relates to a product and method for stabilizing the juice of citrus, and specifically to a product and method for stabilizing the juice of lemons.

### DESCRIPTION OF THE RELATED ART

Citrus originated about 20 million years ago in Southeast Asia. They have since undergone many changes due to both natural selection and hybridization as manmade. The dispersion of citrus from their places of origin was mainly due to the great migrations, conquests of Alexander the Great spread of Islam, crusades, discovery of America, etc. Studies in the year 1980 the name Tahiti is because it was introduced in California from the island of Tahiti, in the period 1850-1880; and the Persian lime, for coming for the Mediterranean, from Persia place now known as Iran. It is a hybrid triploid, where one parent is an acid lime and the other a citron.

The Tahiti lime is a product of extensive culture, its specific origin is unknown, it is presumed to be a hybrid between Citrus aurantifolia and other citrus species, it is also identified as the Tahiti lime (Citrus latifolia Tanaka). The origin of its origin is Burma, Malaysia and the islands of Indonesia, where he went to India and from there was brought to the Mediterranean areas. In del875 he appeared in California and from there was brought to Ecuador adapting mainly in subtropical valleys, the start of commercial plantations were given just 10 years ago and has great international demand.

The main feature of Tahiti lime is their lack of seed, oval and also has a dark green color during development and then become yellow or light green in the stage of maturation. It is considered mature or ready to eat when you can squeeze the juice easily. The standard maturation is technically defined as the minimum juice content is 42% by volume and at least 45 mm in diameter of the fruit.

The fruit of this measure weighs about 54 grams (1.9 ounces), this state of the plant is obtained within 90 to 120 days after flowering, depending on climatic conditions and orchard management. Fruit shell having a thickness of 2 to 3 mm, the fruit is usually a slurry or nipple end style, vary considerably in size and shape. The tree is of medium size, can grow to five meters high, it has a round crown. Lemon is rich in minerals including potassium, magnesium, calcium and phosphorus stand (also contains sodium, iron and fluoride).

Potassium, for example, is essential for life and beneficial for the treatment of hypertension element. It has some B vitamins (BI, B2, B3, B5, B6, PP). Vitamin BI (thiamine) prevents and cures beriberi disease whose symptoms are paralysis, edema and heart failure. Also involved in the metabolism of carbohydrates. Vitamin PP (niacin) warns against rough skin, pellagra, a disease that is manifested by inflammation of the skin, poor digestion and mental disorders. This vitamin is necessary to maintain healthy skin, digestive system and nervous system.

It is a fruit that could be defined as medicinal par excellence because it acts as a curative in more than 150 diseases where toxins either in the blood, organs, tissue, lemon are once ingested comes to combat dissolving their accruals and expel them.

In cases of gastrointestinal poisoning from eating bad food or bad food or combine heavy and pains digestion of the liver and gallbladder, lemon acts normalizing altered functions, neutralizing toxins and helping their elimination. It is also a major consumer of microbes and the best protector against infectious diseases.

In cases of fever it helps eliminate oxidizing and excreting toxic that are not properly neutralized and eliminated, except rheumatic fever. Lemon is good in cases of hypertension, arteriosclerosis and cardiovascular disease (activating blood circulation), in diabetes contributes to avoid complications related to arteries. Prevents the formation of kidney stones and can reach dissolve slowly.

Like any drug consumption is directly linked to the physical condition of each person because, although it is a great ally of health also its consumption should be restricted against particularized situations, you may be suffering from an individual being in such cases the not indicated consumption.

### SUMMARY OF THE INVENTION

This section is for the purpose of summarizing some aspects of the present invention and to briefly introduce some embodiments. Simplifications or omissions may be made to avoid obscuring the purpose of the section. Such simplifications or omissions are not intended to limit the scope of the present invention.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’ is used in relation to one or more steps in a method or process.

In one aspect, the invention is about a method for stabilizing lemon juice, said method comprising: providing a lemon squeezer machine having a 100% natural fiber cloth enclosing said machine's lemon squeezing mechanism, extracting the lemon juice from two lemon pieces without allowing the natural oil contained within a lemon peel to mix with said juice, wherein said oil is isolated from said juice through the placement of an oil absorbing 100% natural fiber cover over the outside of the lemon skin in the squeezing mechanism of said machine, manually straining any lemon seeds from said lemon juice, heating said lemon juice to a temperature range of between 60 centigrade and 77 centigrade for between 30 and 60 seconds, thermal shock cooling of said lemon juice to between 0 centigrade and 30 centigrade and storing said lemon juice at a temperature of between −10 centigrade and 25 centigrade for at least 10 days. In another aspect adding xanthan gum to the cooled lemon juice at a ratio of 0.01% to 0.25% by weight of said lemon juice. In yet another aspect adding ascorbic acid and/or citric acid to the cooled lemon juice at a ratio of 1% to 2% by weight of said lemon juice. In another aspect adding glucose to the cooled lemon juice at a ratio of 0.5% to 2.0% by weight of said lemon juice. In yet another aspect adding sodium benzoate and/or potassium sorbate to the to the cooled lemon juice at a ratio of 0.25% to 1.0% by weight of said lemon juice.

In one aspect, the invention is about a method for stabilizing lemon juice comprising: providing a lemon squeezing machine having a 100% natural fiber cloth enclosing said machine's lemon squeezing mechanism, extracting the lemon juice from two lemon pieces without allowing the natural oil contained within the lemon peel to mix with said juice, wherein said oil is isolated from said juice through the placement of an oil absorbing 100% natural fiber cover over the outside of the lemon skin in the squeezing mechanism of said machine, manually straining any lemon seeds from said lemon juice, heating said lemon juice to a temperature range of between 60 centigrade and 77 centigrade for between 30 and 60 seconds, thermal shock cooling of said lemon juice to between 0 centigrade and 30 centigrade; and storing said lemon juice at a temperature of between-10 centigrade and 25 centigrade for at least 10 days. In another aspect adding xanthan gum to the cooled lemon juice at a ratio of 0.01% to 0.25% by weight of said lemon juice. In yet another aspect adding ascorbic acid and/or citric acid to the cooled lemon juice at a ratio of 1% to 2% by weight of said lemon juice. In another aspect adding glucose to the cooled lemon juice at a ratio of 0.5% to 2.0% by weight of said lemon juice. In yet another aspect adding sodium benzoate and/or potassium sorbate to the to the cooled lemon juice at a ratio of 0.25% to 1.0% by weight of said lemon juice.

Other features and advantages of the present invention will become apparent upon examining the following detailed description of an embodiment thereof, taken in conjunction with the attached drawings, which are provided for purposes of illustration and not of limitation.

### BRIEF DESCRIPTION OF THE DRAWINGS

FIG. 1 shows a flowchart of the proposed process, according to an exemplary embodiment of the invention.

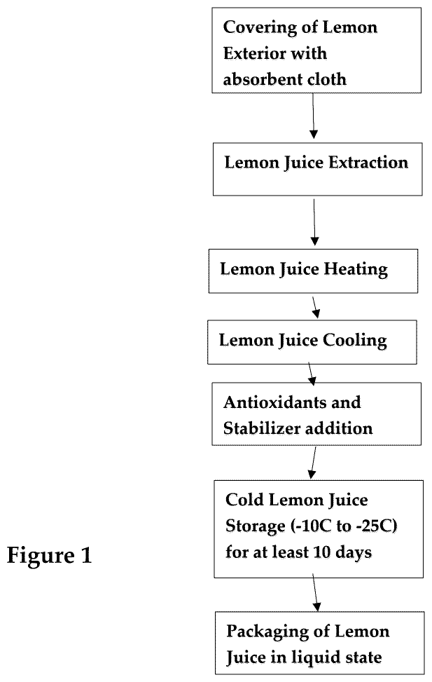

The above-described and other features will be appreciated and understood by those skilled in the art from the following detailed description and drawings.

### DETAILED DESCRIPTION OF THE INVENTION

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

As used in the specification and claims, the singular forms “a”, “an” and “the” include plural references unless the context clearly dictates otherwise. For example, the term “a transaction” may include a plurality of transaction unless the context clearly dictates otherwise.

As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

The preparation and use of various forms of this invention provides many applicable inventive concepts that can be incorporated into a wide plurality of specific contexts such as packaging in sachet, bottle and bag used for commercial, industrial and medicinally.

The stabilization process is performed lemon juice in a food processing plant itself, considering the following phases:
1) removing the lemon is selected overripe fruit, leaves, branches and debris.
2) lemons are washed by immersion in water,
3) lemons are disinfected by immersion in water disinfectant special food for at least 5 minutes.
4) They turn to go through water to remove any residual disinfectant.
5) Cut lemon into 2 parts.
6) place an oil absorbing 100% natural fiber cover over the outside of the lemon skin in the squeezing mechanism of said machine, so that the cover in the squeezer machine absorbs the natural oils of the lemon peel.
7) the lemon pieces are placed in the squeezer machine so as to extract the juice of lemon.
8) any lemon seeds in the lemon juice are immediately extracted through manual filtering.
9} is heated immediately seeded lemon juice (to prevent bitter) at a temperature ranging from a minimum of 60 * C up to 95° C. in a time range between 30 and 60 seconds.
10) The hot lemon juice is cooled down by heat shock at a temperature in a range between 30° C. and O “C 11) antioxidant stabilizers and the lemon juice were added.
12) The stabilized lemon juice is stored in cold temperature of −10° C. to −25 “C for at least 10 days.
13) The lemon juice is stabilized in liquid state is packed in special packaging (plastic laminate, bilayer coextruded polyester, 12-gauge polyethylene) or glass to prevent lemon acidity corrode the packaging container.

### ADVANTAGES OF THE INVENTION

The product obtained by the stabilization process allows:

Keep frozen for more than two years preserving their organoleptic and physical properties while Keep it up to 12 months at room temperature preventing the breakdown and growth of fungi, yeasts and bacteria that affect their physical and organoleptic characteristics.

Let's be handled, stored and transported smoothly for any climate while maintaining all physical and organoleptic characteristics.

Its composition is of 94.75% natural lemon juice.

### CONCLUSION

In concluding the detailed description, it should be noted that it would be obvious to those skilled in the art that many variations and modifications can be made to the shown embodiments without substantially departing from the principles of the present invention. Also, such variations and modifications are intended to be included herein within the scope of the present invention as set forth in the disclosure.

It should be emphasized that the above-described embodiments of the present invention, particularly any “exemplary embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention.

We claim:

1. A method for stabilizing lemon juice, said method comprising:
providing a lemon squeezer machine having a 100% natural fiber cloth enclosing said machine's lemon squeezing mechanism;
extracting the lemon juice from two lemon pieces without allowing the natural oil contained within a lemon peel to mix with said juice, wherein said oil is isolated from said juice through the placement of an oil absorbing 100% natural fiber cover over the outside of the lemon skin in the squeezing mechanism of said machine;
manually straining any lemon seeds from said lemon juice;
heating said lemon juice to a temperature range of between 60 centigrade and 77 centigrade for between 30 and 60 seconds;
thermal shock cooling of said lemon juice to between 0 centigrade and 30 centigrade; and
storing said lemon juice at a temperature of between −10 centigrade and 25 centigrade for at least 10 days.

2. The method of claim 1 wherein;
adding xanthan gum to the cooled lemon juice at a ratio of 0.01% to 0.25% by weight of said lemon juice.

3. The method of claim 1 wherein;
adding ascorbic acid and/or citric acid to the cooled lemon juice at a ratio of 1% to 2% by weight of said lemon juice.

4. The method of claim 1 wherein;
adding glucose to the cooled lemon juice at a ratio of 0.5% to 2.0% by weight of said lemon juice.

5. The method of claim 1 wherein:
adding sodium benzoate and/or potassium sorbate to the to the cooled lemon juice at a ratio of 0.25% to 1.0% by weight of said lemon juice.

6. A method for stabilizing lemon juice comprising:
providing a lemon squeezing machine having a 100% natural fiber cloth enclosing said machine's lemon squeezing mechanism;
extracting the lemon juice from two lemon pieces without allowing the natural oil contained within the lemon peel to mix with said juice, wherein said oil is isolated from said juice through the placement of an oil absorbing 100% natural fiber cover over the outside of the lemon skin in the squeezing mechanism of said machine;
manually straining any lemon seeds from said lemon juice;
heating said lemon juice to a temperature range of between 60 centigrade and 77 centigrade for between 30 and 60 seconds;
thermal shock cooling of said lemon juice to between 0 centigrade and 30 centigrade; and
storing said lemon juice at a temperature of between −10 centigrade and 25 centigrade for at least 10 days.

7. The method of claim 6 wherein;
adding xanthan gum to the cooled lemon juice at a ratio of 0.01% to 0.25% by weight of said lemon juice.

8. The method of claim 6 wherein;
adding ascorbic acid and/or citric acid to the cooled lemon juice at a ratio of 1% to 2% by weight of said lemon juice.

9. The method of claim 6 wherein;
adding glucose to the cooled lemon juice at a ratio of 0.5% to 2.0% by weight of said lemon juice.

10. The method of claim 6 wherein:
adding sodium benzoate and/or potassium sorbate to the to the cooled lemon juice at a ratio of 0.25% to 1.0% by weight of said lemon juice.
